(19) United States
(12) Patent Application Publication
(10) Pub. No.: US 2011/0153881 A1
(43) Pub. Date: Jun. 23, 2011

(54) Portable Multipurpose Computer - MC

(76) Inventor: Danny Ace, Tacoma, WA (US)

(21) Appl. No.: 12/970,886

(22) Filed: Dec. 16, 2010

Related U.S. Application Data
(60) Provisional application No. 61/289,398, filed on Dec. 23, 2009.

(51) Int. Cl. G06F 13/10

(52) U.S. Cl. 710/62

(57) ABSTRACT

A Portable Multipurpose Computer (MC) that has a very compact size and is easy to use and transport. The MC can be wirelessly connected to external displays, keyboards, and other devices or be used in mobile mode with a built-in display and keyboard. The universal device connectivity of the MC and its pocket size enables anyone to use the same computer at work, home, while traveling or at any other location without having to carry bulky laptops, replicating data and using additional equipment. Therefore, the MC saves substantial resources, time and finances while making the user more efficient and productive. Moreover, the MC offers tremendous advantages by providing cutting-edge and portable computer power that can be used anywhere. In addition, the MC includes the functionality of a mobile phone, data storage, media player and other devices. These features make MC the Universal Computing, Communication and Media Device.

### CROSS-REFERENCE TO RELATED APPLICATIONS

This application claims the benefit of provisional application No. 61/289,398, filed Dec. 23, 2009 by present inventor.

### FIELD

The present invention relates to portable computers, specifically to portable multipurpose computers having a very compact size.

### PRIOR ART

One of the most important requirements of a computer system is its portability as well as ease of use and transport. The best solution so far to address this issue has been the development of a notebook or a laptop. Even though the laptops are portable, they are bulky and are not easy to transport. No matter how good the technology gets in reducing the size of CPU, RAM, Data Storage and other computing components, the screen and the keyboard still need to be large enough for the laptop to be used easily and efficiently. Specifically, the screen needs to be large enough to display at least a page of information and the keyboard needs to include all standard keys. Therefore, because the laptop includes a large screen and a standard keyboard as part of its structure, the overall size remains relatively big and cannot be reduced enough to be transported easily. Thus, the size of the screen and the keyboard prevent the laptop from becoming a true portable, easy to use and transport, pocket-size computer. Moreover, by keeping the regular screen and the standard keyboard as part of a portable computer structure, we are not utilizing the tremendous advancements in computer science that significantly improve the capabilities, size and speed of computing components.

In addition, the amount of different electronic devices such as computers, mobile phones, data storage devices, media players, etc., is growing every day. The technology improvements in component size and computing power enable us to combine all these items in one useful device. We don't need to purchase, carry and work with separate devices, while we could do it all with just one!

Therefore, insofar as I am aware, no computer system or device provide a compact, pocket-size, portable, easy to transport computer power and combine the functionality of a computer, mobile phone, media player and other electronic devices.

### SUMMARY

A portable Multipurpose Computer (MC) that has a very compact size and can be wirelessly connected to external peripherals including displays, keyboards, mice or other devices, services and networks. In addition, the MC combines functionalities of a computer, mobile phone, electronic storage device, media player and functionality of virtually any other electronic device. The portable Multipurpose Computer, also referred to as “MC”, is the next step in evolution of a personal computer and a laptop.

The development of the computer technology made significant advancements in speed and size, while the size of the screen and the keyboard must remain the same for efficient use of the computer. Therefore, to make the computer truly portable as well as easy to use and transport, the MC removes the dependency of a computer system (such as laptop) on being physically attached to a large screen and a keyboard whose size cannot be sufficiently reduced. The MC provides portable computer power that can fit in a pocket without the need to carry displays, keyboards, mice and other devices. Instead, the MC wirelessly (or otherwise) connects to displays of any size, keyboards, mice and other devices, services or networks at any location.

These advantages allow the user to employ the same computer at the office, home, airplane, car, or any other location, while simultaneously using the MC as a mobile phone, data storage, media player or as any other device. The MC users won't need to carry bulky laptops, transfer files and data between different computers to synchronize or duplicate information, buy a stand alone cell phone and other electronic devices. Instead, the MC can be used anywhere universally in a mobile mode or by connecting it (wirelessly or otherwise) with displays, keyboards, mice and other devices at work, home or while traveling.

### BRIEF DESCRIPTION OF THE DRAWINGS

FIG. 1 : MC Component Overview

FIG. 2 : Top View of the MC

FIG. 3 : MC at work while wirelessly(or otherwise) connected to other devices

FIG. 4 : MC in use at different locations

FIG. 5 : MC as a Universal Computer, Communication and Media Device

FIG. 6 : MC design with a coupled display

FIG. 7 : MC design with a sliding display

FIG. 8 : MC design with touch-sensitive display

REFERENCE NUMERALS

100 Portable Multipurpose Computer Main Body (MC Main Body)

102 Computer

104 CPU(s)

106 RAM

108 Data Storage

110 Other computer components

112 Telecommunications Module

114 Other Electronic Devices and components

116 External Device Interface (wireless / cable)

200 MC Frame

202 Screen

204 Miniature Keyboard and buttons

300 MC at work

302 Display (any size or type)

304 Keyboard/Touch-board

306 Mouse (or any pointing device)

308 Internet

310 Printer

312 Wireless connection signals or cables

314 Other Devices, services or networks

400 MC in use in different locations

402 Work

404 Home

406 Travel

408 Conference/Data sharing

410 Car

500 MC as a Universal Computer, Communication and Media device

502 Laptop

504 Mobile Phone

506 Data Storage

508 Media Player

510 Other Electronic Devices

602 Coupled Display

604 Keyboard

702 Sliding Display

704 Keyboard

800 Main Computer Body

801 Touch-sensitive Display

### DETAILED DESCRIPTION

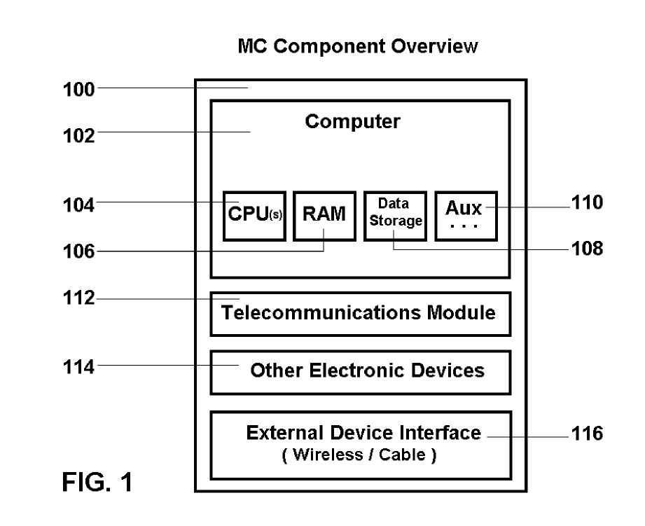

FIG. 1 presents the major components of the Portable Multipurpose Computer (MC). The MC main body 100 comprises the computer 102 with one or more CPUs 104, RAM 106, Data Storage 108 and other auxiliary Computer Components 110 such as Cache, Bus, etc., necessary for a fast and efficient computer operation. The MC main body 100 also contains the telecom module 112 that provides telecommunication means, enabling the user to employ the MC as a mobile phone, fax or other communication device. In addition, the MC 100 comprises other Electronic Devices 114 such as data storage, media player, microphone, camera, security system, GPS, and so on. These devices constitute data, media, video and other utility means. The MC 100 architecture also contains an External Device Interface 116 which provides a means to wirelessly (or cable) connect the MC to any display, keyboard, mouse or any other external device, service or network, including the internet.

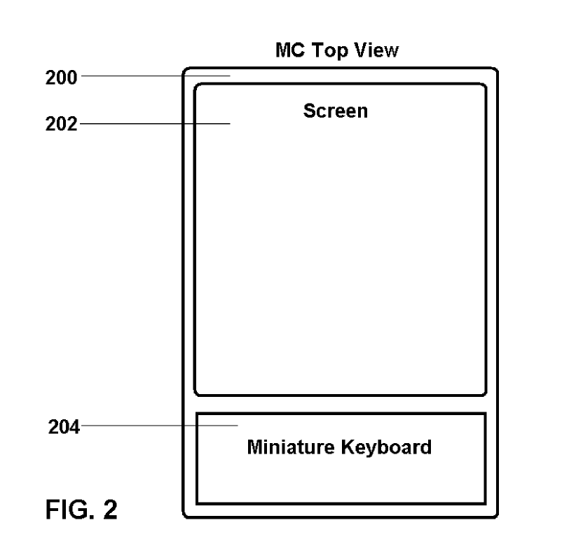

Referring now to FIG. 2. FIG. 2 is a top view of the MC in general terms. The MC frame 200 contains the touch-sensitive Screen 202 that serves to display and enter information. Specifically, the built-in touch-sensitive display 202 will enable the user to select menus, icons or other objects. Thus, the screen 202 can provide both, an input and output means for the MC. In addition, the built-in display 202 enables the MC to function independently.

The MC frame 200 also has an optional built-in Keyboard/Touch-board 204 and other buttons and devices necessary for easy use and operation of the MC in mobile and stationery modes. The keyboard 204 constitute an input means for the MC as well.

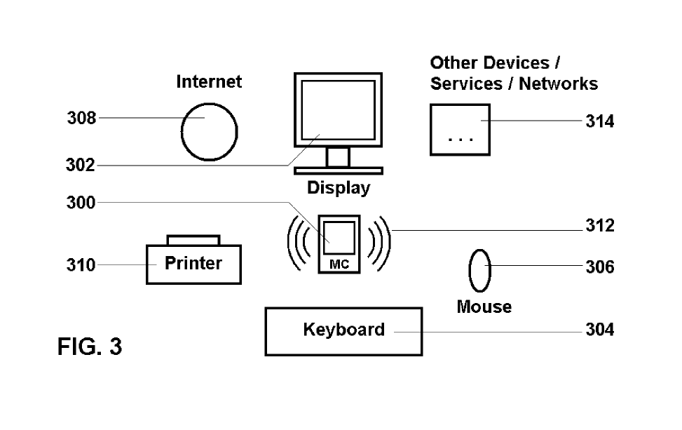

Referring now to FIG. 3. FIG. 3 presents the Multipurpose Computer 300 at work. Specifically, it shows the MC 300 Wirelessly (or otherwise) Connected 312 to any size or type of a Display 302, a Keyboard/touch-board 304, Mouse (or any pointing device) 306, Internet 308, Printer 310, or any other Device, Service or Network 314.

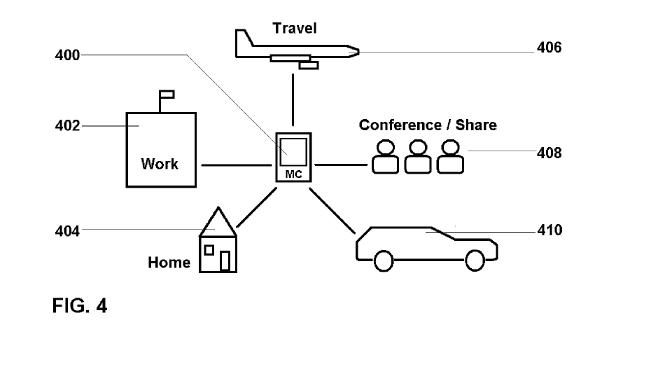

Referring now to FIG. 4. FIG. 4 presents the MC 400 in use in different locations. The same MC 400 can be used at Work 402, at Home 404, during Travel 406 in mobile or stationery mode at any location. The MC can also be used at a conference or to share information with other people 408 by connecting to multiple screens, computers or other MCs.

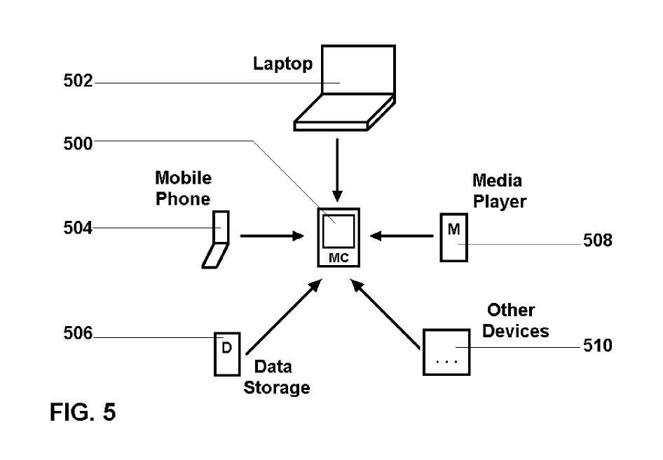

Referring now to FIG. 5. FIG. 5 shows the MC 500 as a universal computer, communication and media device. The MC 500 has combined the functionality of many electronic devices such as Laptop 502, Mobile Phone 504, Data Storage, 506, Media Player 508 and other devices 510.

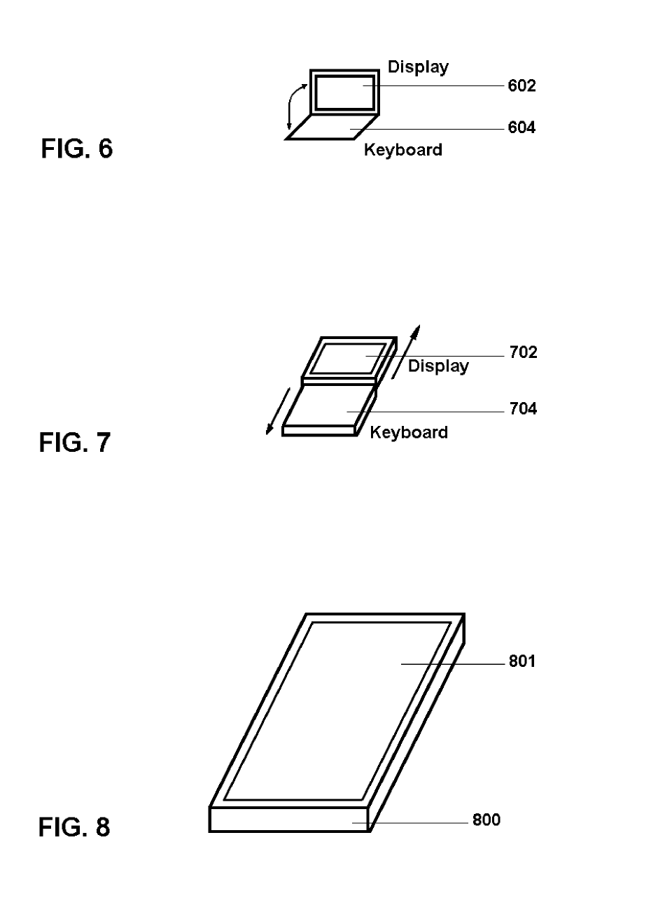

Referring now to FIGS. 6, 7, 8. These figures provide an alternative MC design.

FIG. 6 presents MC design with a coupled Display 602 and a built-in keyboard 604. In this design, the body of MC comprises two parts coupled together. The top part has a built-in Display 602 and the bottom part has a built-in keyboard 604. The MC can be closed during transport and opened during operation, providing access to the keyboard 604 and the display 602.

FIG. 7 presents MC design with a sliding Display 702 and a built-in keyboard 704. In this design, the MC comprises two parts that can slide apart. One part has a built-in display 702 and a second part has a built-in keyboard 704. The two parts can be joined together during transport and slide apart to expose the display 702 and keyboard 704 during MC use.

FIG. 8 shows MC design with a touch-sensitive Display 801. In this design, the touch sensitive display 801 is built-in main computer body 800 and is used for displaying and entering data. Thus, the display 801 constitute both, input and output means. Specifically, the touch-sensitive display 801 can show a virtual keyboard and process user input. In addition, the display 801 enables the user to select displayed items, application menus or other objects. The advantages of this design enable us to increase the screen area, using the space otherwise taken by the built-in keyboard, and, further reduce the size of the MC.

Operation

The portable Multipurpose Computer (MC) can successfully be used at any location as shown in FIG. 4 with a setup presented in FIG. 3. For example, the user can employ the MC 400 at his/her workstation at the office 402 by wirelessly (or otherwise) connecting it to the external display 302, keyboard 304, mouse 306, internet 308 and other devices, networks and services 314 as shown in FIG. 3. Then, the user can take the same MC 400 to any other location (another office, building, conference room, airplane, home, etc.) to continue working, sharing information or telecommuting using the same computer. Therefore, there will be no need to transfer or duplicate data and software on other computers, laptops, and devices which can be very time consuming and costly. The MC will also save businesses and users substantial resources that are typically spent to acquire additional computers and equipment. The MC 400 offers a tremendous advantage by providing portable and easy to use and transport computer power that can be used anywhere. In addition, the MC can be used independently in mobile mode by using the built-in display and keyboard in places where external displays, keyboards and other devices are unavailable.

The MC is a universal computing, communication and media device as shown in FIG. 5. In addition to being a portable computer, the MC has additional applications. It can be used as a mobile phone 504, data storage device 506, media player 508, camera or any other electronic device 510. The MC users won't need to carry, pack and deal with a plethora of electronic devices. Instead, they will have them all in just one easy to use device.

Advantages

The advantages of the portable Multipurpose Computer (MC) include, without limitation, that it is portable, small in size as well as easy to use and transport. The MC can be wirelessly (or otherwise) connected to external displays, keyboards, mice and other devices or be used in a mobile mode with the built-in keyboard and display. The MC allows the user to work with the same computer at the office, home, while traveling or at any other location. In addition, the MC has a functionality of a mobile phone, media player, data storage device and any other electronic device. This makes the MC the Universal Computing, Communication and Media Device.

Conclusions, Ramifications and Scope

Clearly, the portable Multipurpose Computer (MC) has tremendous advantages when compared with other systems. The MC is a very compact, pocket- size, easy to transport and yet very powerful computer. The MC can be used in mobile or stationery mode, wirelessly connecting to any display, keyboard, service or network at any location. Thus, the MC can be effortlessly transferred and employed at work, home, during travel or at any other place. Moreover, the MC significantly enhances the portability by enabling the user to transport only the necessary computing components without large peripherals such as regular-size display and standard-size keyboard. This means the user won't need to carry bulky laptops, use different computers, duplicate data, reinstall software and work with extra equipment. Therefore, the MC saves substantial resources, time and finances while making the user more efficient and productive. In addition, the user can use the MC as mobile phone, data storage, digital camera or any other utility device, providing the user with additional functionality.

While the above description contains many specificities, these should not be construed as limitations on the scope, but rather as an exemplification of preferred embodiments thereof. Many other variations, combinations and equivalents of the embodiments, methods and examples are possible. For example:

In addition to having independent functionality, The MC could be connected with remote systems such as servers, supercomputers, databases, etc., tapping into their resources.

The telecommunications means could be implemented by using the internet connection and technologies such as VoIP (Voice over Internet Protocol), without relying on conventional mobile communication devices.

To further reduce the size, the MC could exclude built-in keyboard or display, working with external I/O peripherals. In addition, the MC could exclude any utility devices such as mobile phone, media player, etc., to provide pure portable computer power to the user.

The MC could easily be operated by voice commands.

Thus, the scope should be determined not by the embodiments, methods and examples illustrated, but by the appended claims and their legal equivalents.

Further, the purpose of the foregoing description is to enable the U.S. Patent and Trademark Office, the public generally, and especially the scientists, engineers and those skilled in the art to appreciate that the conception, upon which this disclosure is based, may readily be utilized as a basis for the designing of other embodiments, structures, methods and systems for carrying out the purposes of the present invention. It is important, therefore, that the claims be regarded as including such equivalent constructions.

I claim:

1. A portable multipurpose computer, comprising:
a computer main body having a compact size, a CPU provided in said computer main body, an input means built-in said computer main body, an output means built-in said computer main body, and means for connecting said portable computer to external devices, built-in said computer main body,
whereby (a) creating a portable computer of significantly reduced size (b) excluding large peripherals such as regular-size screen and standard keyboard from the computer structure, (c) providing the user with easily transportable, pocket-size computer power, (d) creating an optimal portable computer architecture, wherein the overall computer size is determined mainly by the size of computing components rather than peripherals (e) said portable computer can be independently operable using said input means and said output means, (f) said portable computer can be easily operable with external displays, keyboards, electronic devices, networks and services using said means for connecting to external devices, and (g) enabling a user of said portable computer to employ the same computer at work, home, while traveling or at any other location.

2. The portable computer of claim 1, further including a data storage means built-in said computer main body.

3. The portable computer of claim 1, further including telecommunications means built-in said computer main body.

4. The portable computer of claim 1, further including media playing means built-in said computer main body.

5. The portable computer of claim 1, further including a digital camera.

6. A portable computer, comprising:
a computer main body having a compact size, a CPU provided in said computer main body, a display built-in said computer main body, and an external device interface,
whereby (a) said portable computer is easily transportable due to its compact size, (b) said portable computer can work independently, (c) said portable computer can work with external displays, keyboards, electronic devices, networks and services using said external device interface, and (d) enabling a user of said portable computer to employ the same computer at work, home, while traveling or at any other location.

7. The portable computer of claim 6, wherein said display is touch-sensitive.

8. The portable computer of claim 6, further including a keyboard.

9. The portable computer of claim 6, further including a data storage device.

10. The portable computer of claim 6, further including a microphone and a speech recognition module.

11. The portable computer of claim 6, further including telecommunications module.

12. The portable computer of claim 6, further including media playing device.

13. The portable computer of claim 6, further including a security system.

14. The portable computer of claim 6, further including a digital camera.

15. A method of enhancing the usability of a portable computer, comprising:
reducing the size of said portable computer by excluding large peripheral components from the computer structure, and
wirelessly connecting said portable computer to peripherals, including displays, keyboards, mice, as well as other devices, services and networks,
whereby (a) enabling the user to carry only the necessary computing components, such as the CPU, RAM and Data Storage, (b) significantly reducing width and length of said portable computer, (c) allowing the user to easily transfer said portable computer between different locations, and (d) saving the user time and resources usually spent to acquire additional equipment.

16. The method of claim 15, further including providing a built-in pocket-size display for mobile and independent operation.

17. The method of claim 15, further including providing a built-in pocket-size display and a keyboard for mobile and independent operation.

18. The method of claim 15, further including providing a microphone and a telecommunication module.

19. The method of claim 15, further including providing a data storage, digital camera, media player, microphone, security system, GPS or any other useful device.

20. The method of claim 15, further including providing an operating system, business, personal, speech recognition or any other useful software applications.
